(19) United States
(12) Patent Application Publication
(10) Pub. No.: US 2024/0308056 A1
(43) Pub. Date: Sep. 19, 2024

(54) TRUSS ASSEMBLY TABLE WITH PRESSING MECHANISMS

(71) Applicant: Illinois Tool Works Inc., Glenview, IL (US)

(72) Inventors: Mathew Nickolas Milton, Carrollton, TX (US); Ronald E. Findley, Arlington, TX (US); Steven E. Daniels, Georgetown, TX (US); Heather M. Veach, Waco, TX (US); John L. Carmical, Hewitt, TX (US); Caleb Scarbrough, Waco, TX (US)

(21) Appl. No.: 18/596,072

(22) Filed: Mar. 5, 2024

Related U.S. Application Data
(60) Provisional application No. 63/490,586, filed on Mar. 16, 2023.

(51) Int. Cl. B25H 1/10; B25H 1/02

(52) U.S. Cl. CPC B25H 1/10; B25H 1/02

(57) ABSTRACT

A truss assembly table including a table frame, a tabletop, a first pressing mechanism, and a second pressing mechanism, wherein the pressing mechanisms are each configured to apply an even amount of force to the chord members and chords of a truss built on the truss assembly table during the truss assembly process and thus reduce the likelihood that the truss will be improperly built.

### PRIORITY CLAIM

This application claims priority to and the benefit of U.S. Provisional Patent Application Ser. No. 63/490,586, filed Mar. 16, 2023, the entire contents of which are incorporated herein by reference.

### BACKGROUND

Wooden trusses are widely used throughout the construction industry. Wooden trusses are often constructed from conventional dimensional lumber members (such as what is commonly known as: a 2 by 4; a 2 by 6; or a 2 by 8). The wooden members that are used to build a wooden truss are sometimes called truss members in general with the most common truss member types sometimes called chord members and web members. Such chord members often extend longitudinally along the length of the truss and such web members often extend transversely to the length of the truss and along the width of the truss. Wooden trusses are often built from numerous truss members and metal connectors. The metal connectors are used to attach the truss members to form the wooden truss. Wooden trusses are often prefabricated in a factory and then shipped to a construction site where the wooden trusses are used to construct part of the structure of a building (such as a house or commercial facility). Buildings constructed with such prefabricated wooden trusses are often more economical and faster to construct than buildings constructed with conventional stick framed structures.

Various truss assembly tables have been developed. Various known truss assembly tables are used for manufacturing floor trusses that are employed to form a floor supporting structure. One issue with various known truss assembly tables is that they can apply uneven pressing forces to one or more of the chord members (and thus the web member) of the truss during the truss assembly process. In certain situations, such uneven pressing forces can result in an improperly built truss, which in turn can result in a weakness of or a failure of the truss. Accordingly, there is a need for improved truss assembly tables that address this issue.

### SUMMARY

The present disclosure provides a truss assembly table with one or more pressing mechanisms that overcome(s) the above described issue. In various embodiments, the truss assembly table includes a table frame, a tabletop, a first pressing mechanism, and a second pressing mechanism, wherein the first and second pressing mechanisms are each configured to uniformly engage and apply an even amount of force to the chord members and web members of a truss being built on the truss assembly table.

Additional features and advantages of the present disclosure are described in, and will be apparent from, the following Detailed Description and the Figures.

### BRIEF DESCRIPTION OF THE FIGURES

FIG. 1 is a top perspective or isometric view of a known truss assembly table.

FIG. 2 is a fragmentary top perspective or isometric section view of a truss assembly table including pressing mechanisms in accordance with one example embodiment of the present disclosure, and showing a part of a truss being built on a first side of the truss assembly table.

FIG. 3 is an enlarged fragmentary top perspective view of the truss assembly table of FIG. 2 showing parts of the pressing mechanisms of the truss assembly table, and showing a part of a truss being built on a second side of the truss assembly table.

FIG. 4 is a fragmentary end perspective of part of the truss assembly table of FIG. 2 showing parts of the pressing mechanisms of the truss assembly table, and showing part of a truss being built on the first side of the truss assembly table.

FIG. 5 is an enlarged fragmentary end perspective of part of the truss assembly table of FIG. 2 showing parts of the pressing mechanisms of the truss assembly table, and showing a part of a truss being built on a first side of the truss assembly table.

FIG. 6 is a fragmentary end perspective of part of the truss assembly table of another example embodiment of the present disclosure showing parts of the pressing mechanisms of the truss assembly table with certain alternative component configurations, and showing part of a truss being built on a second side of the truss assembly table.

FIG. 7 is a fragmentary bottom perspective or isometric section view of part of a pressing mechanism and part of a tabletop of a truss assembly table of an alternative embodiment of the present disclosure.

FIG. 8 is a fragmentary top perspective or isometric section view of part of the pressing mechanism of the truss assembly table of FIG. 7.

### DETAILED DESCRIPTION OF EXAMPLE EMBODIMENTS

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

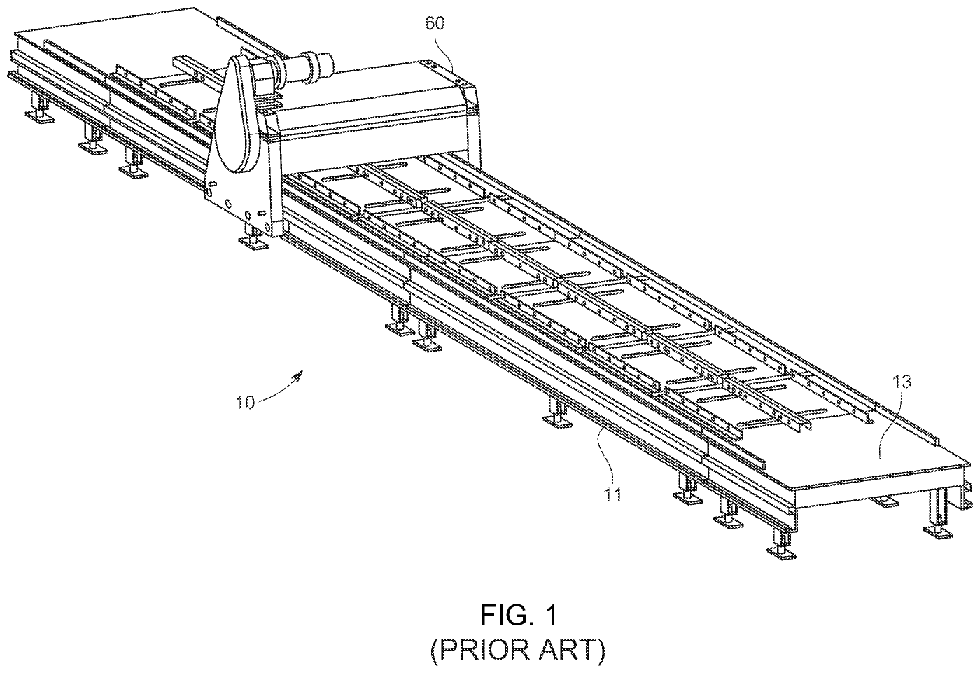

FIG. 1 shows a known truss assembly table 10. This known truss assembly table 10 generally includes: (a) a table frame 11; (2) a tabletop 13; and (3) a movable gantry 60. This known truss assembly table 10 is configured for simultaneously building two floor trusses on the truss assembly table 10 in a side by side manner on the tabletop 13. This known truss assembly table 10 is also configured for simultaneously building two or more floor trusses on the truss assembly table 10 on each side in an end-to-end manner on the tabletop 13.

The present disclosure relates to improvements to known truss assembly tables (such as the truss assembly table shown in FIG. 1), and particularly provides a truss assembly table with one or more pressing mechanisms that are configured to uniformly apply pressing forces to the chord members and web member of trusses being built on the truss assembly table during a truss assembly process of those trusses on the truss assembly table. The uniform pressing forces applied to the chord members and web member of the respective trusses reduces the likelihood that the trusses will be improperly built. Example embodiments of a truss assembly table configured for simultaneously forming two floor trusses in accordance with the present disclosure are discussed below; however, it should be appreciated that the present disclosure is not limited to the illustrated example floor truss assembly tables. For brevity, various components of the truss assembly table of the present disclosure are not described herein because such components are well known in the industry.

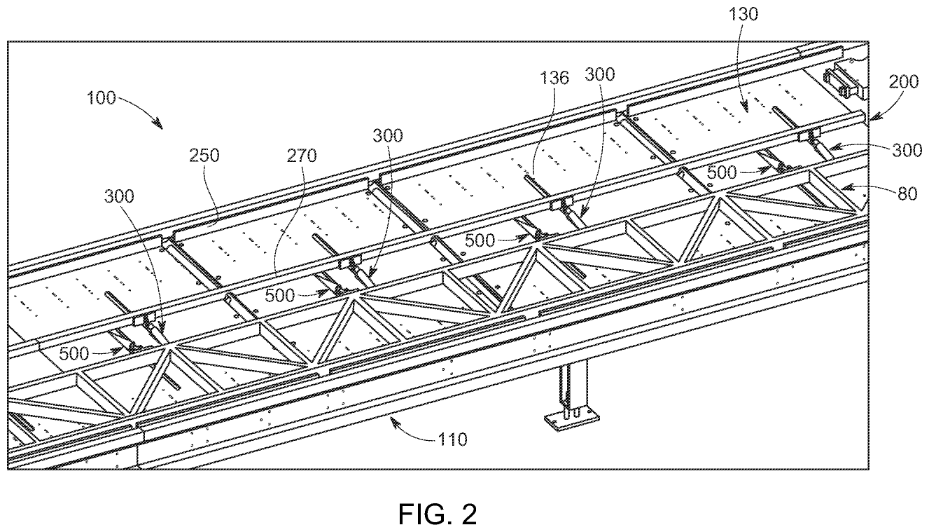

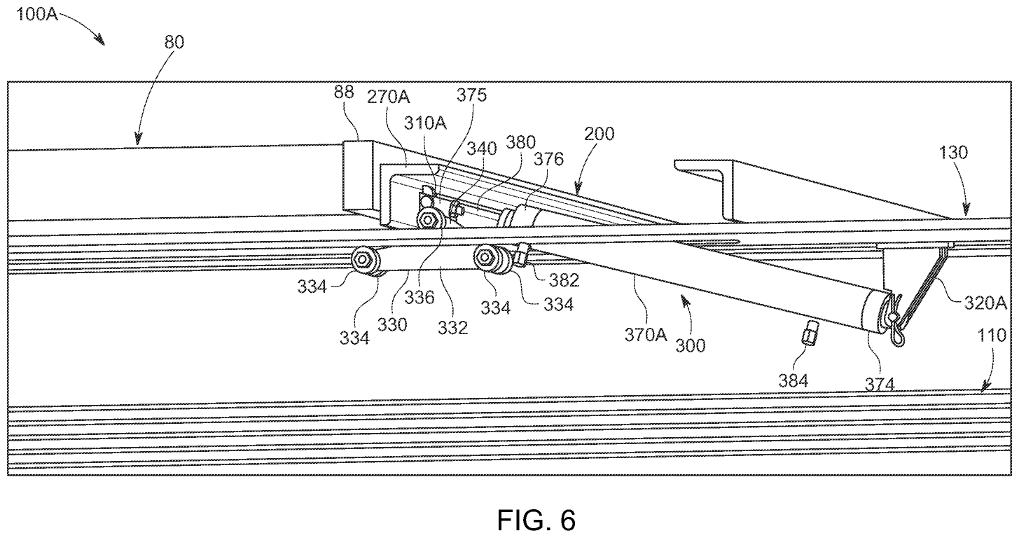

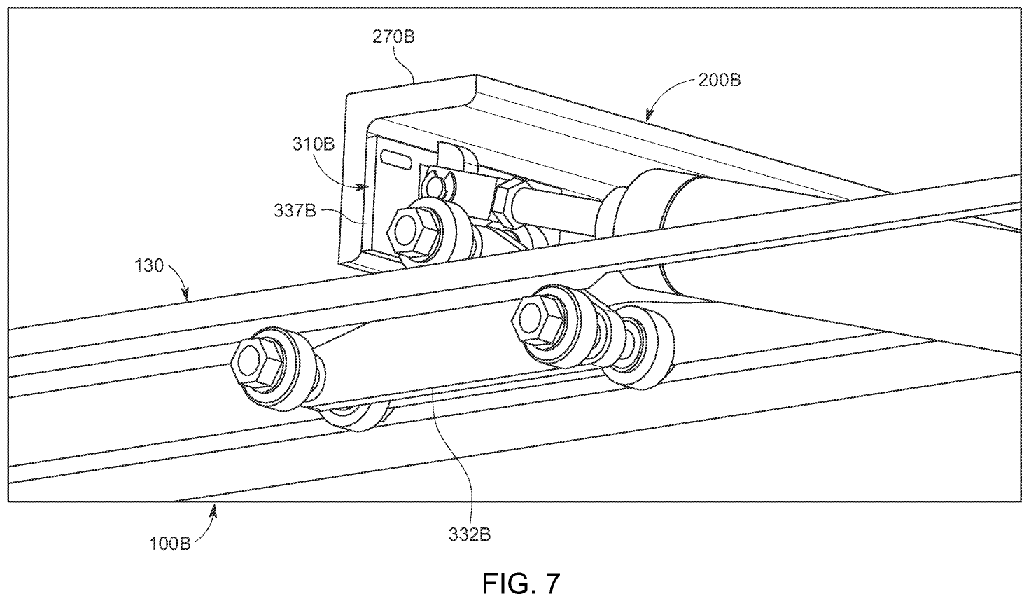

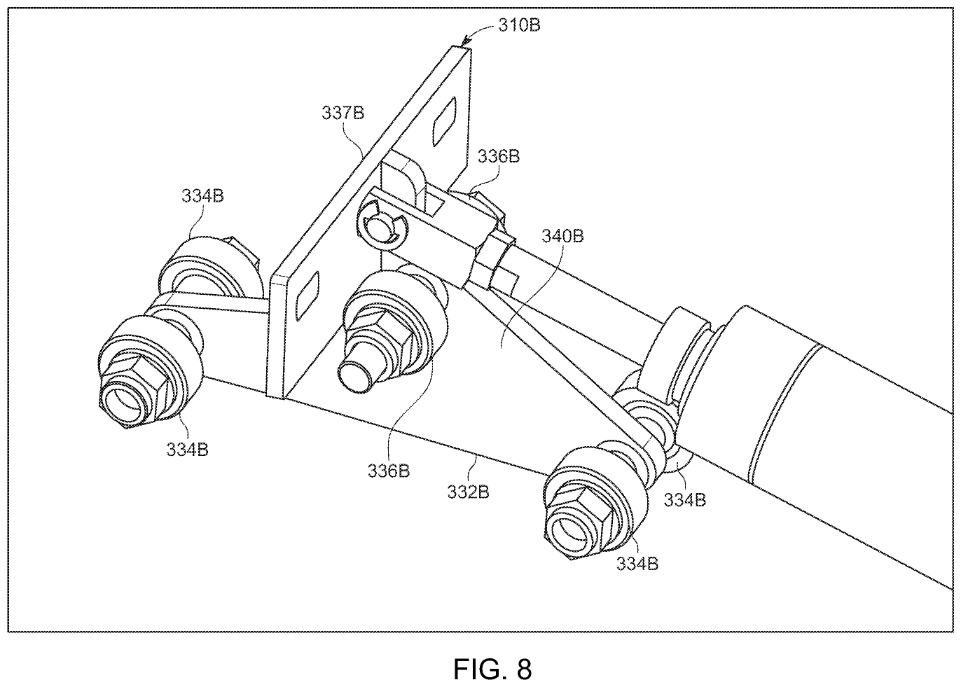

FIGS. 2, 3, 4, and 5 generally illustrate one example embodiment of a truss assembly table in accordance with the present disclosure. The truss assembly table of this example illustrated embodiment is indicated by numeral 100. FIG. 6 shows a truss assembly table 100A with certain alternative configurations for certain of the components of the truss assembly table 100 as described below. FIGS. 7 and 8 show a truss assembly table 100B with certain alternative configurations for certain of the components of the truss assembly table 100 as described below.

The example illustrated truss assembly table 100 generally includes: (a) a table frame 110; (2) a tabletop 130; (3) a first pressing mechanism 200; (4) a second pressing mechanism 400; (5) a gantry (not shown); (6) a controller (not shown); (7) an operator interface (not shown); and (8) a power supply (not shown).

More specifically, the table frame 110 includes a plurality of frame components (not individually labeled) that are configured and connected in a suitable manner to support the other components of the truss assembly table 100. These frame components can take any suitable shape, can be formed is any suitable manner, and can be formed from any suitable materials. The table frame 110 has a longitudinal length that is longer than any truss to be built on the truss assembly table 100. The table frame 110 has a transverse width that is more than twice the width of any truss to be built on the truss assembly table 100 (to enable two or more trusses to be simultaneously built on the truss assembly table 100).

The tabletop 130 is supported by the table frame 110, has a longitudinal length that is longer than any truss to be built on the truss assembly table 100, and has a transverse width that is more than twice the width of any truss to be built on the truss assembly table 100 (to enable two or more trusses to be simultaneously built on the truss assembly table 100). The tabletop 130 includes one or more horizontally extending members (not labeled), wherein the upper most member includes an upper build surface 136 on which trusses being built on the truss assembly table 100 can rest. The tabletop 130 can be formed is any suitable manner and can be formed from any suitable materials.

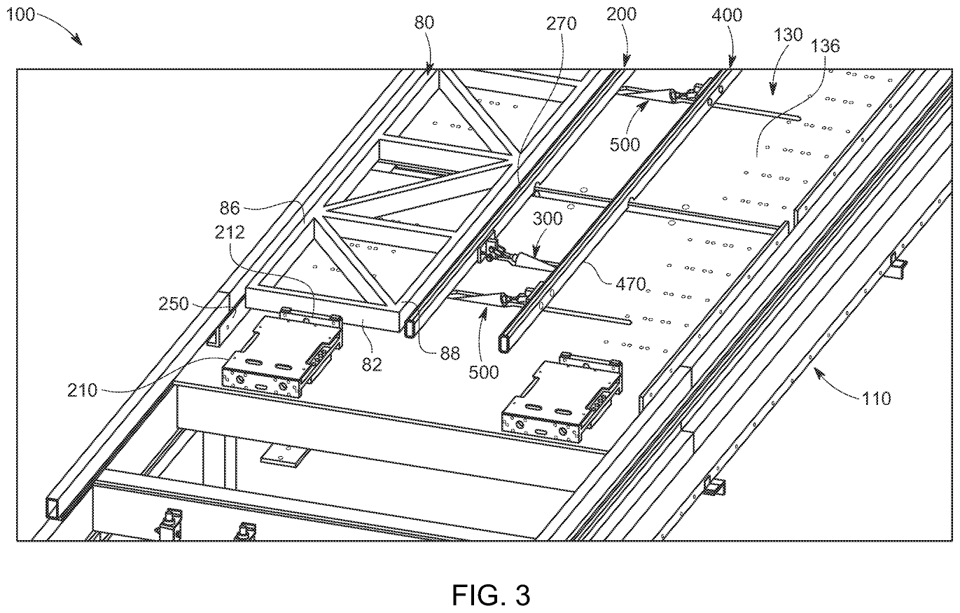

The first truss pressing mechanism 200 includes: (a) a first-end-cord-member engager 210; (b) a second-end-cord-member engager (not shown); (c) a stationary outer-web-member engager 250; (d) a movable inner-web-member engager 270; and (e) a plurality of spaced-apart inner-web-member-engager movers 300. These components are configured to work together to uniformly engage, suitably press against, and hold the respective chord members and web members of a truss (such as example truss 80 shown in FIG. 3) that is being built on the truss assembly table 100.

More specifically, the first-end-cord-member engager 210 is positioned above, on, and fixedly connected to the tabletop 130 at one longitudinal end of the tabletop 130 such as shown in FIG. 3. The first-end-cord-member engager 210 can include one or more chord engagers such as chord engager 212. The first-end-cord-member engager 210 is configured to engage and apply suitable force to the outer surface of the web member at one end of a truss being built on the truss assembly table 100 (such as the web member 82 of the truss 80 shown in FIG. 3). The first-end-cord-member engager 210 can be alternatively configured. For example, it may include a stationary engagement member instead of having a movable press engagement member.

The second-end-cord-member engager (not shown) is identical to the first-end-cord-member engager 210 and is positioned above, on, and fixedly connected to the tabletop 130 at a suitable longitudinal distance away from the first-end-cord-member engager 210 at an opposite longitudinal end of the tabletop 130. The second-end-cord-member engager can include one or more chord engagers. The second-end-cord-member engager is configured to engage and apply suitable force to the web member at the opposite end of a truss being built on the truss assembly table 100 (such as a web member (not shown) at an opposite end of the truss 80 shown in FIG. 3). The second-end-cord-member engager can be alternatively configured. For example, it may include a stationary engagement member instead of having a movable press engagement member.

The stationary outer-web-member engager 250 is positioned above, on, and fixedly connected to the tabletop 130 at an outer transverse side of the tabletop 130 such as shown in FIGS. 2 and 3. The stationary outer-web-member engager 250 is configured to engage the outer surface of the outer longitudinally extending chord member at one longitudinal side of a truss being built on the truss assembly table 100 (such as the chord member 86 of the truss 80 shown in FIG. 3). In FIGS. 2 and 3, the stationary outer-web-member engager 250 is shown as an elongated upside down L-shaped angle iron, but it should be appreciated that the stationary outer-web-member engager 250 can be configured in other suitable manners. For example, the outer-web-member engager 250 can be in an elongated tubular form.

The movable inner-web-member engager 270 is movably supported and positioned above the tabletop 130 at a relatively central transverse position of the tabletop 130 such as shown in FIGS. 2, 3, 4, and 5. The inner-web-member engager 270 is movable from: (1) a first retracted non-engagement position in which the inner-web-member engager 270 is spaced from and does not engage the inner chord member of a truss being built on the truss assembly table 100 (such as shown in FIGS. 3, 4, and 5) to (2) a second extended engagement position in which the inner-web-member engager 270 engages the inner chord member of a truss being built on the truss assembly table 100, and back to the first non-engagement position. In the second engagement position, the inner-web-member engager 270 is configured to uniformly engage the inner chord member of a truss being built on the truss assembly table 100 and to apply even forces to that inner chord member (and thus the web members) of the truss. In FIGS. 2, 3, 4, and 5, the movable inner-web-member engager 270 is shown in an elongated tubular form, but is should be appreciated that the movable inner-web-member engager 270 can be configured in other suitable manners in accordance with the present disclosure. For example, as shown in FIG. 6, the movable inner-web-member engager 270A is shown as an elongated upside down L-shaped angle iron. FIG. 7 also shows the movable inner-web-member engager 270B as an elongated upside down L-shaped angle iron.

The inner-web-member engager 270 is movable by the plurality of spaced-apart inner-web-member-engager movers 300. The plurality of inner-web-member-engager movers 300 are configured to operate in unison to move the inner-web-member engager 270 from: (a) the retracted non-engagement position in which the inner-web-member engager 270 does not engage the inner chord member of the truss; to (b) the extended engagement position in which the inner-web-member engager 270 uniformly engages the longitudinal outer side surface of the inner chord member of the truss and applies an even uniform amount of pressure to the inner chord member of the truss as further described below. The quantity, positions, and spacing of the plurality of inner-web-member-engager movers 300 can vary in accordance with the present disclosure. Each of the plurality of inner-web-member-engager movers 300 are identical in this example embodiment, so for brevity, only one inner-web-member-engager mover 300 is described herein in detail. Additionally, for brevity, the inner-web-member-engager mover 300 is sometimes referred to herein as the mover 300.

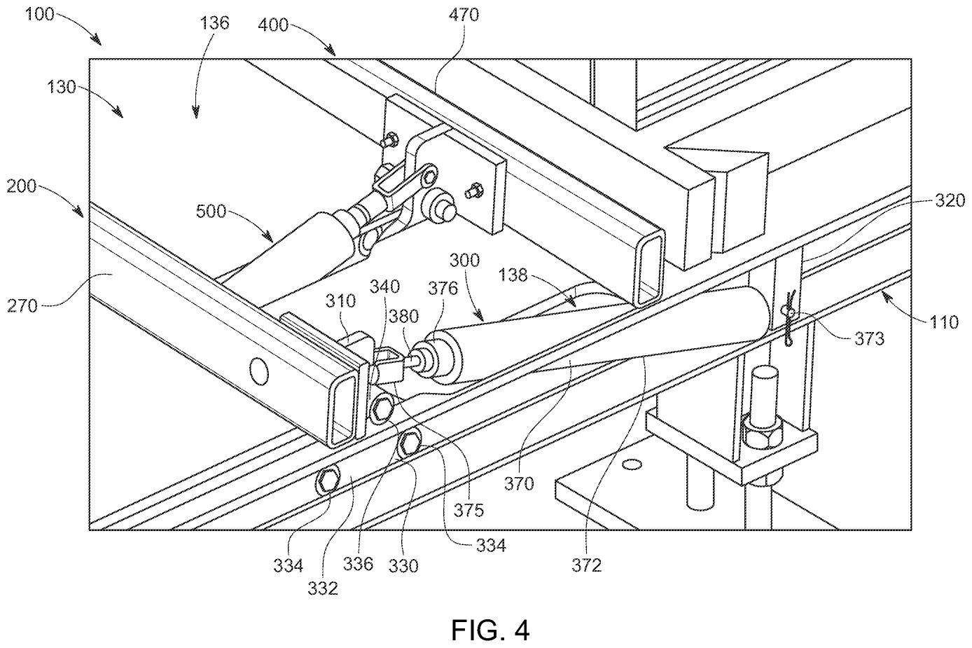

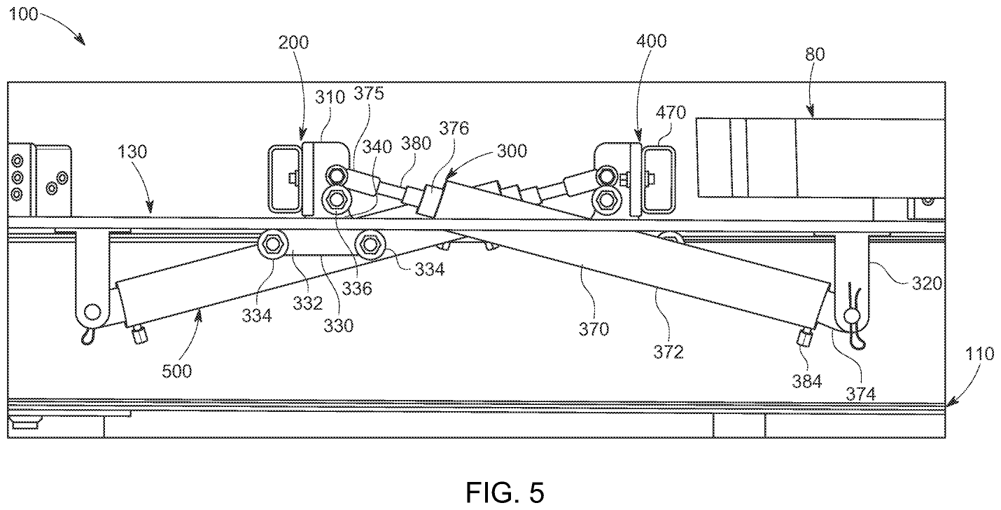

As best shown in FIGS. 4 and 5, the inner-web-member-engager mover 300 includes: (1) a first attachment bracket 310; (2) a second attachment bracket 320; (3) a movable stabilizing roller assembly 330; and (4) an actuator 370. The embodiment shown in FIG. 6 shows example alternative configurations of certain of these components. FIGS. 7 and 8 show further alternative configurations of certain of these components.

The first attachment bracket 310 is suitably fixedly connected to the inner-web-member engager 270 and extends transversely inwardly from the inner-web-member engager 270. The first attachment bracket 310 is also suitably fixedly connected (above the tabletop 130) to the stabilizing roller assembly 330 and suitably pivotally connected to the upper end of the actuator 370 that is above the tabletop 130, as further described below. FIGS. 4 and 5 show one example configuration of the first attachment bracket 310. FIG. 6 shows another example configuration of the first attachment bracket 310A. FIGS. 7 and 8 show another example configuration of the first attachment bracket 310B. The first attachment bracket can thus be configured in any suitable manner and made from any suitable material.

The second attachment bracket 320 is suitably connected to the bottom of the tabletop 130 and extends downwardly from the bottom of the tabletop 130. The second attachment bracket 320 is also suitably pivotally connected (below the tabletop 130) to the lower end of the actuator 370 as further described below. FIGS. 4 and 5 show one example configuration of the second attachment bracket 320. FIG. 6 shows another example configuration of the second attachment bracket 320A. The second attachment bracket can thus be configured in any suitable manner and made from any suitable material.

The stabilizing roller assembly 330 includes: (a) a transversely extending trolley base 332; (b) one or more (such as four) lower wheels 334 connected to the trolley base 332; (c) an upwardly extending trolley arm 340; and (d) one or more (such as two) upper wheels 336 connected the trolley arm 340. More specifically, the trolley base 332 extends transversely below the truss table 130 and includes front and rear ends (not labeled). In this example embodiment, two of the four lower wheels 334 are freely rotatably connected to the front end of the trolley base 332 and two of the four lower wheels 334 are freely rotatably connected to the rear end of the trolley base 332. The trolley arm 340 is fixedly connected to the trolley base 332 between the front and rear ends of the trolley base 332, and extends upwardly from the trolley base 332 through a transversely extending opening 138 in the tabletop 130 and is fixedly connected at its top end to the first attachment bracket 310. The two upper wheels 336 are freely rotatably connected to the trolley arm 340 above the tabletop 130. Thus, (1) the trolley base 332 and wheels 334 are positioned below the tabletop 130 such that the lower wheels 334 can engage the bottom surface of the tabletop 130, (2) the trolley arm 340 can move transversely through the opening 138 in the tabletop 130 such that the upper wheels 336 can engage the upper build surface 136 of the tabletop 130, and such that the trolley arm 340 provides support for the first attachment bracket 310. The stabilizing roller assembly 330 (including the trolley base 332) is thus configured to transversely move with the first attachment bracket 310 and provide support for the first attachment bracket 310 and thus the inner-web-member engager 270.

FIGS. 7 and 8 show that the first attachment bracket 310B includes: (a) a transversely extending trolley base 332B; (b) four lower wheels 334B connected to the trolley base 332; (c) an upwardly extending trolley arm 340B; (d) two upper wheels 336B connected the trolley arm 340; and (e) a connection member 337B connected to the trolley arm 340B and configured to be attached to the inner-web-member engager 270B.

The actuator 370 as best shown in FIGS. 4 and 5 includes a pneumatically powered cylinder having: (a) a cylinder bore end 372 extending above, though, and below the tabletop 130; (b) a first cylinder bore end clevis mount 374 connected to a first end of the cylinder bore end 372 (below the tabletop 130) and pivotally connected (below the tabletop 130) to the second attachment bracket 320 by a pivot pin assembly (not labeled); (c) a second cylinder bore end 376 connected (above the tabletop 130) to a second end of the cylinder bore end 372; (d) a movable piston (not shown) in the cylinder bore end 372; (e) a movable piston rod 380 having a first end connected to the piston and a second end connected to a pivot mount 375, wherein the pivot mount 375 is pivotally connected by a pivot pin assembly (not labeled) connected to the first attachment bracket 310; and (f) two air inlet/outlet ports 382 and 384. FIGS. 4 and 5 show one configuration for the actuator 370. FIG. 6 shows an alternative configuration for the actuator 370A. The actuator is pneumatically powered in this example embodiment. However, it should be appreciated that the actuator could be powered in other suitable manners in accordance with the present disclosure. For example, the actuator can be formed from a suitably electrically powered solenoid. The actuator 370 and particularly the cylinder bore end 372 of the actuator 370 extends through the transverse opening 138 in the tabletop 130 to create the desired angle for the pressure applied to the inner-web-member engager 270 to prevent backwards rotation of the inner-web-member engager 270.

The second truss pressing assembly 400 is a mirror image of the first truss pressing assembly 400 and is thus not described in detail herein.

The gantry includes any suitable gantry that is longitudinally moveable relative to the tabletop 130 and configured to secure attachment plates to the chord members and the chords of a truss in a conventional manner or in a manner to be developed in the future.

In various embodiments, the controller includes a suitable switching mechanism that is manually controlled.

In various other embodiments, the controller can be a PLC board or integrated into a PLC board.

In various other embodiments, the controller includes a processing device (or devices) communicatively connected to a memory device (or devices). For instance, the controller can be a programmable logic controller.

The processing device can include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine.

The memory device can include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the truss assembly table 100.

The controller is communicatively and operably connected to the actuators, the operator interface, and the power supply, and configured to receive signals from and send signals to those components. The controller can also be communicatively connectable (such as via Wi-Fi, Bluetooth, near-field communication, or other suitable wireless communications protocol) to an external device, such as a computing device, to send information to and receive information from that external device.

The operator interface can include a suitable display screen with a touch panel. In such embodiments with a display screen, the display screen is configured to display information regarding the truss assembly table 100, and the touch screen is configured to receive operator inputs. The operator interface is communicatively connected to the controller to send signals to the controller and to receive signals from the controller. Other embodiments of the truss assembly table 100 do not include a touch panel. Still other embodiments of the truss assembly table 100 do not include a display assembly. Certain embodiments of the truss assembly table 100 include a separate pushbutton panel instead of a touch panel beneath or integrated with the display screen. In certain embodiments of the truss assembly table 100, the operator interface includes one or more pushbuttons (and associated light) and no display screen or touch panel.

In various embodiments, the power supply is electrically connected to (via suitable wiring and other components) and configured to power several components of the truss assembly table 100. In various embodiments, the power supply can include a pneumatic air power supply.

Certain operations of the truss assembly table 100 are now described. While two or more trusses can be built on each side of the truss assembly table 100 at the same time, only the assembly of one truss is discussed herein. Before placing the chord and web members of a truss on the tabletop 130, the movable inner-web-member engager 270 is positioned in the first retracted non-engagement position. The chord and web members of the truss are then placed on the tabletop 130 and suitably positioned. It should be appreciated that the truss assembly table 100 can include suitable positioning members (not shown) that assist in positioning of the chord and web members. The inner-web-member engager 270 then moved to the second extended engagement position in which the inner-web-member engager 270 engages the inner chord member of the truss being built on the truss assembly table 100. This engagement is partially shown in FIG. 6, for example.

The inner-web-member engager 270 engages and presses against the inner chord member in a uniform manner to hold the chord and web members while the attachment plates are secured to chord and web members. Specifically, all of the inner-web-member-engager movers 300 function in unison to move the inner-web-member engager 270. The configuration and specifically the actuators 370 extending from below the tabletop 130 to above the tabletop 130 causes the forces applies by the movers 300 and thus the inner-web-member engager 270 to be toward the top of such engager 270 and thus prevents outward bowing of the truss. In other words, the inner-web-member-engager movers 300 cause the inner-web-member engager 270 to apply more direct pressure to the truss members to prevent such bowing.

After the inner-web-member engager 270 engages and presses against the inner chord member, the attachment plates are positioned on the respective chord and web members of the truss. The gantry then moves over the truss and secures the attachment plates to the chord and web members.

The movable inner-web-member engager 270 is the moved back to the first retracted non-engagement position to enable the built truss to be removed from the truss assembly table 100.

It should be appreciated from the above that various embodiments of the of the present disclosure provide a truss assembly table including: a table frame; a tabletop; and a truss pressing mechanism including: a first-end-cord-member engager, a second-end-cord-member engager, a stationary outer-web-member engager, and a movable inner-web-member engager movable by a plurality of inner-web-member-engager movers, each outer chord member engager mover partially positioned above the tabletop, extending through an opening in the tabletop, and partially positioned below the tabletop. In various such embodiments, each of the inner-web-member-engager movers includes an actuator partially positioned above the tabletop, extending through the opening in the tabletop, and partially positioned below the tabletop. In various such embodiments, each of the inner-web-member-engager movers includes a stabilizing assembly partially positioned above the tabletop, extending through the opening in the tabletop, and partially positioned below the tabletop. In various such embodiments, each of the inner-web-member-engager movers includes a stabilizing assembly partially positioned above the tabletop, extending through the opening in the tabletop, and partially positioned below the tabletop. In various such embodiments, each of the inner-web-member-engager movers includes: a first attachment bracket, a second attachment bracket, a stabilizing assembly partially positioned above the tabletop, extending through the opening in the tabletop, and partially positioned below the tabletop, and an actuator partially positioned above the tabletop, extending through the opening in the tabletop, and partially positioned below the tabletop. In various such embodiments, for each of the inner-web-member-engager movers, the first attachment bracket is connected to the inner-web-member engager, is connected above the tabletop to the stabilizing assembly and is pivotally connected to an upper end of the actuator above the tabletop. In various such embodiments, for each of the inner-web-member-engager movers, the second attachment bracket is connected to the bottom of the tabletop and extends downwardly from the bottom of the tabletop, and the second attachment bracket is pivotally connected below the tabletop to the lower end of the actuator. In various such embodiments, for each of the inner-web-member-engager movers, the stabilizing assembly includes a trolley base, at least one lower wheel connected to the trolley base, a trolley arm, and at least one upper wheel connected the trolley arm. In various such embodiments, for each of the inner-web-member-engager movers, the trolley base extends transversely below the tabletop and includes front and rear ends. In various such embodiments, for each of the inner-web-member-engager movers, wherein two lower wheels are freely rotatably connected to the front end of the trolley base and two lower wheels are freely rotatably connected to the rear end of the trolley base. In various such embodiments, for each of the inner-web-member-engager movers, the trolley arm extends upwardly from the trolley base between the front and rear ends of the trolley base and extends upwardly from the trolley base through the opening in the tabletop and is fixedly connected to the first attachment bracket. In various such embodiments, for each of the inner-web-member-engager movers, wherein two upper wheels are freely rotatably connected to the trolley arm above the tabletop. In various such embodiments, for each of the inner-web-member-engager movers, the stabilizing assembly includes a trolley base, lower wheels connected to the trolley base, a trolley arm, and upper wheels connected the trolley arm, wherein the trolley base and the lower wheels are positioned below the tabletop such that the lower wheels can engage the bottom surface of the tabletop, the trolley arm extends upwardly from the trolley base through the opening in the tabletop such that the upper wheels can engage the build surface of the tabletop, and such that the trolley arm is fixedly connected to the first attachment bracket. In various such embodiments, for each of the inner-web-member-engager movers, the stabilizing assembly is configured to transversely move with the first attachment bracket and provide support for the first attachment bracket and the inner-web-member engager. In various such embodiments, for each of the inner-web-member-engager movers, the actuator includes a pneumatically powered cylinder.

It will be understood that modifications and variations may be affected without departing from the scope of the novel concepts of the present invention, and it is understood that this application is to be limited only by the scope of the claims.

The claims are as follows:

1. A truss assembly table comprising:
a table frame;
a tabletop; and
a truss pressing mechanism including:
a first-end-cord-member engager,
a second-end-cord-member engager,
a stationary outer-web-member engager, and
a movable inner-web-member engager movable by a plurality of inner-web-member-engager movers, each outer chord member engager mover partially positioned above the tabletop, extending through an opening in the tabletop, and partially positioned below the tabletop.

2. The truss assembly table of claim 1, wherein each of the inner-web-member-engager movers includes an actuator partially positioned above the tabletop, extending through the opening in the tabletop, and partially positioned below the tabletop.

3. The truss assembly table of claim 2, wherein each of the inner-web-member-engager movers includes a stabilizing assembly partially positioned above the tabletop, extending through the opening in the tabletop, and partially positioned below the tabletop.

4. The truss assembly table of claim 1, wherein each of the inner-web-member-engager movers includes a stabilizing assembly partially positioned above the tabletop, extending through the opening in the tabletop, and partially positioned below the tabletop.

5. The truss assembly table of claim 1, wherein each of the inner-web-member-engager movers includes
a first attachment bracket,
a second attachment bracket,
a stabilizing assembly partially positioned above the tabletop, extending through the opening in the tabletop, and partially positioned below the tabletop, and
an actuator partially positioned above the tabletop, extending through the opening in the tabletop, and partially positioned below the tabletop.

6. The truss assembly table of claim 5, wherein for each of the inner-web-member-engager movers, the first attachment bracket is connected to the inner-web-member engager, is connected above the tabletop to the stabilizing assembly and is pivotally connected to an upper end of the actuator above the tabletop.

7. The truss assembly table of claim 6, wherein for each of the inner-web-member-engager movers, the second attachment bracket is connected to the bottom of the tabletop and extends downwardly from the bottom of the tabletop, and the second attachment bracket is pivotally connected below the tabletop to the lower end of the actuator.

8. The truss assembly table of claim 5, wherein for each of the inner-web-member-engager movers, the stabilizing assembly includes a trolley base, at least one lower wheel connected to the trolley base, a trolley arm, and at least one upper wheel connected the trolley arm.

9. The truss assembly table of claim 8, wherein for each of the inner-web-member-engager movers, the trolley base extends transversely below the tabletop and includes front and rear ends.

10. The truss assembly table of claim 9, wherein for each of the inner-web-member-engager movers, wherein two lower wheels are freely rotatably connected to the front end of the trolley base and two lower wheels are freely rotatably connected to the rear end of the trolley base.

11. The truss assembly table of claim 10, wherein for each of the inner-web-member-engager movers, the trolley arm extends upwardly from the trolley base between the front and rear ends of the trolley base and extends upwardly from the trolley base through the opening in the tabletop and is fixedly connected to the first attachment bracket.

12. The truss assembly table of claim 11, wherein for each of the inner-web-member-engager movers, wherein two upper wheels are freely rotatably connected to the trolley arm above the tabletop.

13. The truss assembly table of claim 5, wherein for each of the inner-web-member-engager movers, the stabilizing assembly includes a trolley base, lower wheels connected to the trolley base, a trolley arm, and upper wheels connected the trolley arm, wherein the trolley base and the lower wheels are positioned below the tabletop such that the lower wheels can engage the bottom surface of the tabletop, the trolley arm extends upwardly from the trolley base through the opening in the tabletop such that the upper wheels can engage the build surface of the tabletop, and such that the trolley arm is fixedly connected to the first attachment bracket.

14. The truss assembly table of claim 5, wherein for each of the inner-web-member-engager movers, the stabilizing assembly is configured to transversely move with the first attachment bracket and provide support for the first attachment bracket and the inner-web-member engager.

15. The truss assembly table of claim 5, wherein for each of the inner-web-member-engager movers, the actuator includes a pneumatically powered cylinder.
